(19) United States
(12) Patent Application Publication
(10) Pub. No.: US 2009/0016653 A1
(43) Pub. Date: Jan. 15, 2009

(54) Guiding Device for a Synchronous Connector

(76) Inventors: Tsung-Jen Chen, Taichung Industrial Park (TW); Yun-Yi Lin, Taichung Industrial Park (TW)

Correspondence Address: Dr. BANGER SHIA, 102 Lindencrest Ct., Sugar Land, TX, 77479-5201, US

(21) Appl. No.: 11/778,009

(22) Filed: Jul. 13, 2007

(51) Int. Cl. F16C 29/06

(52) U.S. Cl. 384/44; 384/10

(57) ABSTRACT

A guiding device for a synchronous connector comprises a strip-like synchronous connector and at least one connecting member. Both ends of the synchronous connector are formed with two opposite fixing seats. The connecting member with elastic deformation characteristic is serially connected and fixed in the fixing seats at both ends of the synchronous connector, slide correspondingly to the clearance change during the operation of the two ends of the synchronous connector, and bend correspondingly to the turning action of the synchronous connector. By such arrangements, the elastic deformation characteristic of the connecting member can be utilized to avoid the collision interference with the rail wall surface, and the linear guiding device will be circulated smoothly and stably. In addition, the guiding device has the effect of absorbing the radial deformation of the synchronous connector and producing sufficient degree of freedom.

### BACKGROUND OF THE INVENTION

1. Field of the Invention

The present invention relates to a guiding device for a linear guiding device, and more particularly to a guiding device for a synchronous connector which can avoid the collision interference, produce radial degree of freedom and ensure the smooth circulation of the guiding device.

2. Description of the Prior Art

Nowadays, linear guiding device is used more and more in the field of industry, in addition to the effect of high precision, the linear guiding device also has the advantages of low friction, low noise and hard to destroy. Therefore, the linear guiding device is very important to various machines. Generally, the linear guiding device having bearing mainly comprises a slide block, a slide rail and rolling elements disposed therebetween and in linear or turning action. To obtain the following objects, the rolling elements are usually mounted in the chain-shaped synchronous separator one by one.

Firstly, preventing the rolling elements from falling off the slide block when the slide block is disengaged from the slide rail.

Secondly, preventing the rolling elements from contacting each other and increasing the friction resistances.

Thirdly, enabling the rolling elements to be positioned orderly, thus ensuring a smooth circulation.

A conventional connector 10 disclosed in Japan Pat No. 3243415 is shown in FIGS. 1 and 2, between both ends 11 of the connector 10 is formed a gap 12. In addition, both ends of the connector 10 are disconnected. With the influence of the gap 12 between the two ends 11, the conventional connector 10 has the following disadvantages:

Firstly, the connector 10 has the gap 12 formed between both ends 11 of the connector 10, this is a cantilever beam structure, so that the connector 10 is easy to shake, even the ends 11 will impact the return path in turning action, and cause friction between the ends 11 and the return path.

Secondly, when the connector 10 is moving through the return path, since the gap 12 is formed between both ends 11, both ends 11 will be inclined to an outer side of the return path, such that the adjacent rolling elements 13 will be asymmetrical, thus causing an unsmooth action. And the rolling elements 13 will cause interference by colliding and turning repeatedly, so that the rolling elements 13 can not be rolled smoothly.

To solve the above-mentioned problems, an improved synchronous connector 14 disclosed in Japan Pat No. 2607993 and H11-294452 is shown in FIG. 3, both ends 15 and 16 of the synchronous connector 14 are engaged with each other, and a rolling member 17 is disposed in the engaging position of the ends 15 and 16, so as to form an endless connector. However, such a synchronous connector 14 also has the following disadvantages:

The length of the above-mentioned synchronous connector 14 will be changed continuously along the collision of the rolling element 18, so the extension space of the synchronous connector 14 is unable to determine, and the synchronous connector 14 has no radial degree of freedom. As a result, such a synchronous connector 14 is likely to be loosen during operation.

To improve the circulation of the components, and based on the objects of reducing the collision interference and improving the guiding effects, a new guiding device for a synchronous connector is developed.

The present invention has arisen to mitigate and/or obviate the afore-described disadvantages.

### SUMMARY OF THE INVENTION

The primary objective of the present invention is to provide a guiding device for an endless synchronous connector which can operate smoothly.

To achieve the objects of the present invention, a guiding device for a synchronous connector comprises a strip-shaped synchronous connector and at least one connecting member. Both ends of the synchronous connector are formed with two opposite fixing seats. The connecting member with elastic deformation characteristic is serially connected and fixed in the fixing seats at both ends of the synchronous connector, and bend correspondingly to the turning action of the synchronous connector. By such arrangements, the elastic deformation characteristic of the connecting member can be utilized to avoid the collision interference with the rail wall surface, and the linear guiding device will be circulated smoothly and stably.

The second objective of the present invention is to provide a guiding device for a synchronous connector which has radial degree of freedom.

To achieve the objects of the present invention, a guiding device for a synchronous connector with elastic deformation characteristic is serially connected and fixed in the fixing seats at both ends of the synchronous connector, and slide correspondingly to the clearance change during the operation of the two ends of the synchronous connector. By such arrangements, the present invention has the effect of absorbing the radial deformation of the synchronous connector and producing sufficient degree of freedom.

It is to be noted that the fixing seats at both ends of the synchronous connector can be defined with through holes or concave guiding grooves or convex guiding members that can be cooperated with each other or engaged with each other, and the details of the fixing seats are described as follows:

The through holes with certain thickness are defined in both ends of the synchronous connector for receiving the connecting member, and the connecting member is restricted in the thickness of the through holes.

The concave guiding grooves with certain depth are defined in both ends of the synchronous connector for receiving the connecting member, and the connecting member is restricted in the depth of the guiding grooves.

The convex guiding members with certain length are defined in both ends of the synchronous connector for receiving the connecting member, and the connecting member is restricted in the length of the guiding members.

Moreover, the connecting member of the present invention can be a structure with elastic deformation characteristic, such as in the form of a helical spring or a hollow sleeve which is extensible, retractable and bendable, or a hollow tube which is bendable. The sliding of the connecting member between the fixing seats enables the synchronous connector to produce radial degree of freedom, so the synchronous connector will be circulated smoothly.

In addition, both ends of the connecting member can be engaged with the fixing seat, so as to fix the connecting member.

The present invention will become more obvious from the following description when taken in connection with the accompanying drawings, which show, for purpose of illustrations only, the preferred embodiments in accordance with the present invention.

### BRIEF DESCRIPTION OF THE DRAWINGS

FIG. 1 is a perspective view of a conventional connector;

FIG. 2 is an illustrative view of showing the operation of the conventional connector;

FIG. 3 is another perspective view of another conventional connector;

FIG. 4 is an illustrative view of showing a spring-shaped connecting member in accordance with the present invention;

FIG. 5 is a perspective view of a synchronous connector in accordance with the present invention;

FIG. 6 is a perspective view of the spring-shaped connecting member.

FIG. 7A is an assembly perspective view of showing the fixing seat defined with through holes;

FIG. 7B is an assembly cross sectional view of showing the fixing seat defined with through holes;

FIG. 7C is an assembly cross sectional view of showing the connecting member defined with convex guiding members;

FIG. 7D is an assembly cross sectional view of showing the connecting member defined with concave guiding grooves;

FIG. 8 is an illustrative view of showing a tube-shaped connecting member in accordance with the present invention;

FIG. 9 is a perspective view of a synchronous connector in accordance with the present invention;

FIG. 10 is a perspective view of a tube-shaped connecting member;

FIG. 11A is an assembly perspective view of showing the fixing seat defined with through holes;

FIG. 11B is an assembly cross sectional view of showing the fixing seat defined with through holes;

FIG. 11C is an assembly cross sectional view of showing the connecting member defined with concave guiding members;

FIG. 11D is an assembly cross sectional view of showing the connecting member defined with convex guiding grooves;

FIG. 12 is an illustrative view of showing a sleeve-shaped connecting member in accordance with the present invention;

FIG. 13 is another perspective view of the synchronous connector in accordance with the present invention;

FIG. 14 is a perspective view of the sleeve-shaped connecting member;

FIG. 15A is an assembly perspective view of showing the fixing seat defined with through holes; and

FIG. 15B is an assembly cross sectional view of showing the fixing seat defined with through holes.

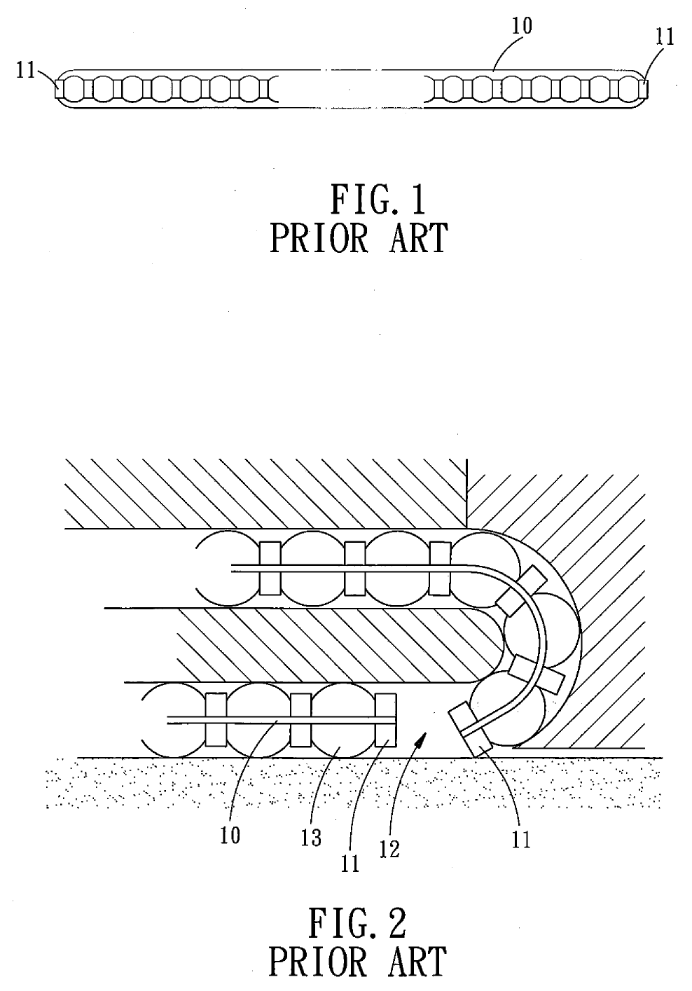

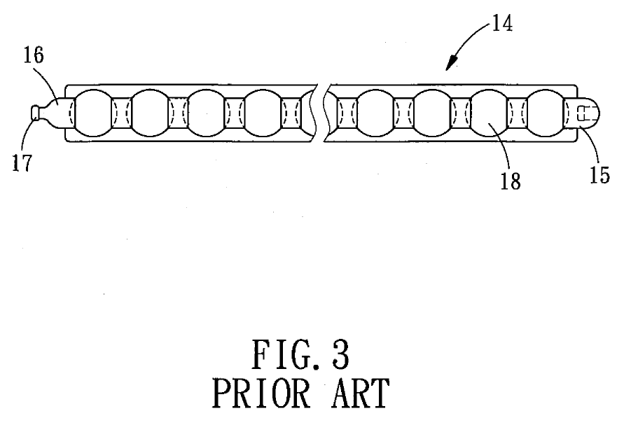

### DETAILED DESCRIPTION OF THE PREFERRED EMBODIMENTS

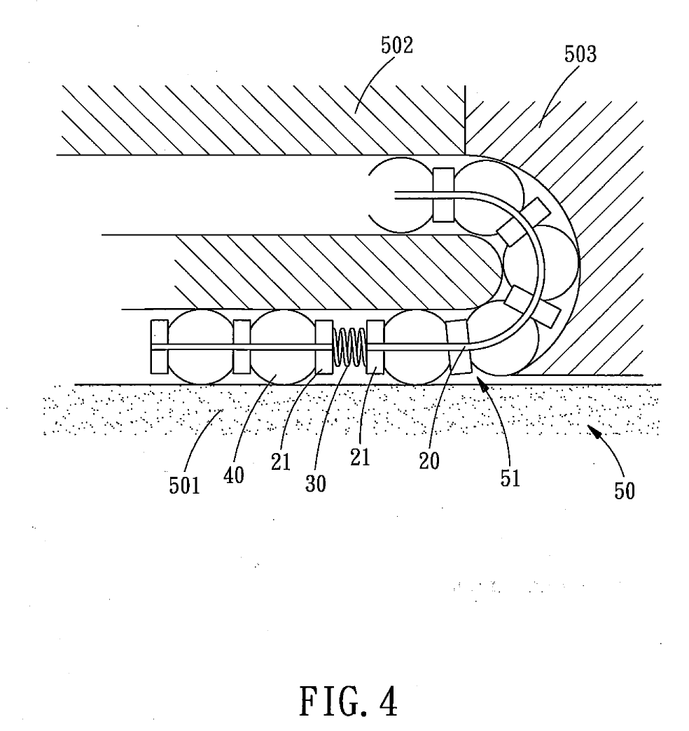

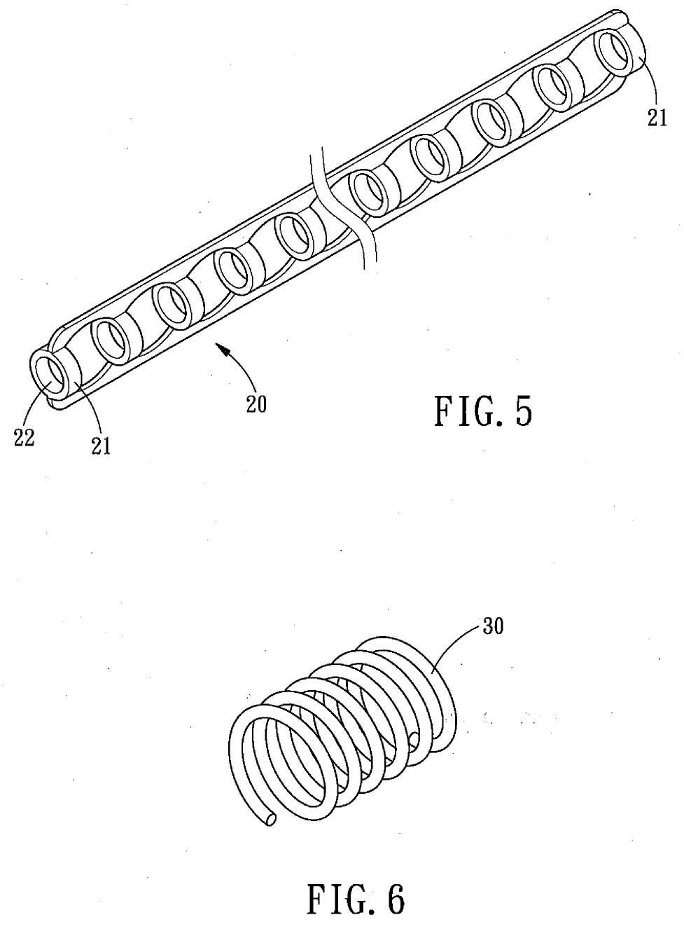

Referring to FIGS. 4-6, 7A and 7B, a guiding device 50 for a synchronous connector in accordance with the present invention is shown, wherein a plurality of rolling elements 40 disposed in a track 51 of the linear guiding device 50, and the linear guiding device 50 comprises a slide rail 501, a slide block 502 and an end cap 503 (the structure and change of the linear guiding device are of conventional techniques and will not be described in detail).

The guiding device 50 for a synchronous connector comprises a strip-shaped synchronous connector 20 and at least one connecting member 30.

Both ends of the synchronous connector 20 are formed with two opposite fixing seats 21 located correspondingly to the moving direction of the rolling elements 40, each fixing seat 21 is defined with a through hole located correspondingly to the path of the synchronous connector 20, and the through hole 22 has a certain thickness T.

The connecting member 30 is in the form of a helical spring which is extensible, retractable and bendable and is serially connected and fixed in the through holes 22 of the fixing seats 21 at both ends of the synchronous connector 20, such that the connecting member 30 is restricted in the depth T of the through holes 22 of the fixing seats 21. The connecting member 30 will slide radially within the depth T of the through holes 22 when it extends or retracts with respect to the synchronous connector 20, therefore, the connecting member 30 is moveable in radial direction. With the elastic deformation characteristic, the connecting member 30 can be bent correspondingly to the turning action of the synchronous connector 20.

Therefore, the elastic deformation characteristic of the connecting member 30 can be utilized to avoid the collision interference with the rail wall surface, and the linear guiding device 50 will be circulated smoothly and stably. In addition, the present invention has the effect of absorbing the radial deformation of the synchronous connector 20 and producing sufficient degree of freedom.

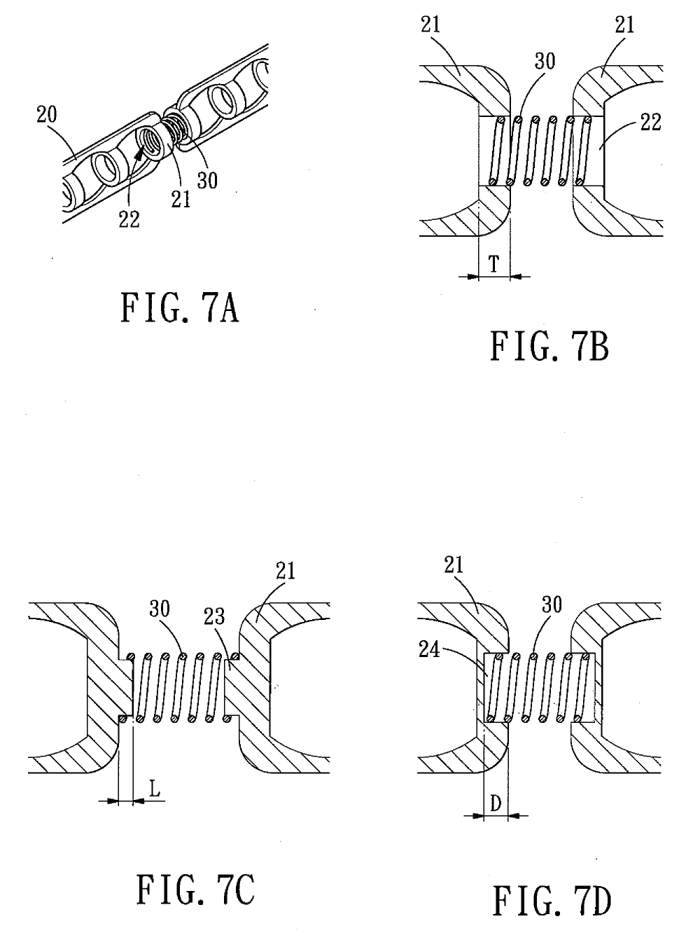

The above-mentioned structure and technique are the details of FIGS. 7A and 7B.

The following descriptions are the embodiments of the synchronous connector 20 of FIGS. 7C and 7D:

Referring to FIG. 7C, both ends of the synchronous connector 20 are formed with two opposite fixing seats 21, each fixing seat 21 is formed with a guiding member 23 with a certain length L. The extensible, retractable and bendable connecting member 30 is in the form of a helical spring and is provided for insertion of the guiding member 23, such that the connecting member 30 is restricted in the length L of the fixing seats 21. The connecting member 30 will slide radially within the length L of the guiding members 23 when it extends or retracts with respect to the synchronous connector 20, therefore, the connecting member 30 is moveable in radial direction. With the elastic deformation characteristic, the connecting member 30 can be bent correspondingly to the turning action of the synchronous connector 20. By such arrangements, the linear guiding device 50 of the present invention can circulate smoothly and stably, and the present invention also has the effect of absorbing the radial deformation of the synchronous connector 20 and producing sufficient degree of freedom.

Referring to FIG. 7D, both ends of the synchronous connector 20 are formed with two opposite fixing seats 21, each fixing seat 21 is formed with a concave guiding groove 24 with a certain depth D. The hollow connecting member 30 is in the form of a helical spring which is extensible, retractable and bendable and is received in the guiding groove 24, such that the connecting member 30 is restricted in the depth D of the fixing seats 21. The connecting member 30 will slide radially within the depth D of the guiding grooves 24 when it extends or retracts with respect to the synchronous connector 20, therefore, the connecting member 30 is moveable in radial direction. With the elastic deformation characteristic, the connecting member 30′ can be bent correspondingly to the turning action of the synchronous connector 20. By such arrangements, the linear guiding device 50 of the present invention can circulate smoothly and stably, and the present invention also has the effect of absorbing the radial deformation of the synchronous connector 20 and producing sufficient degree of freedom.

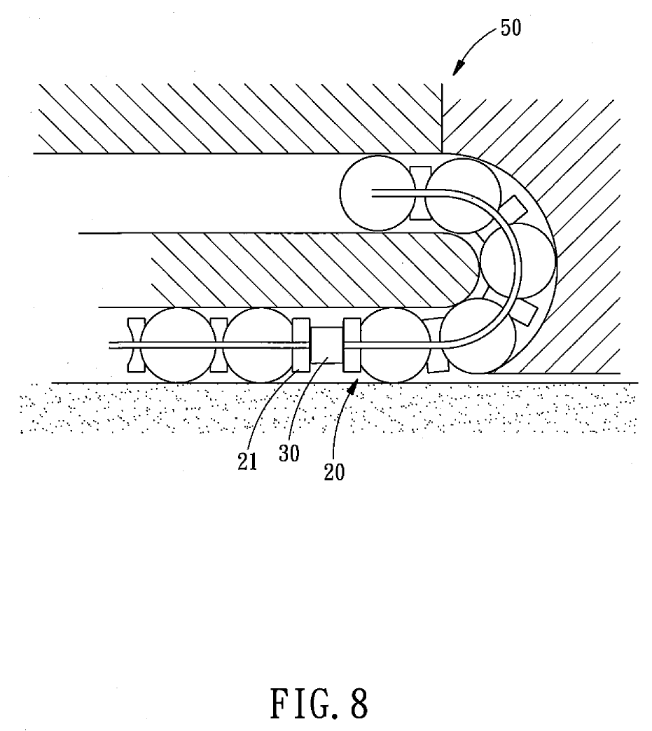

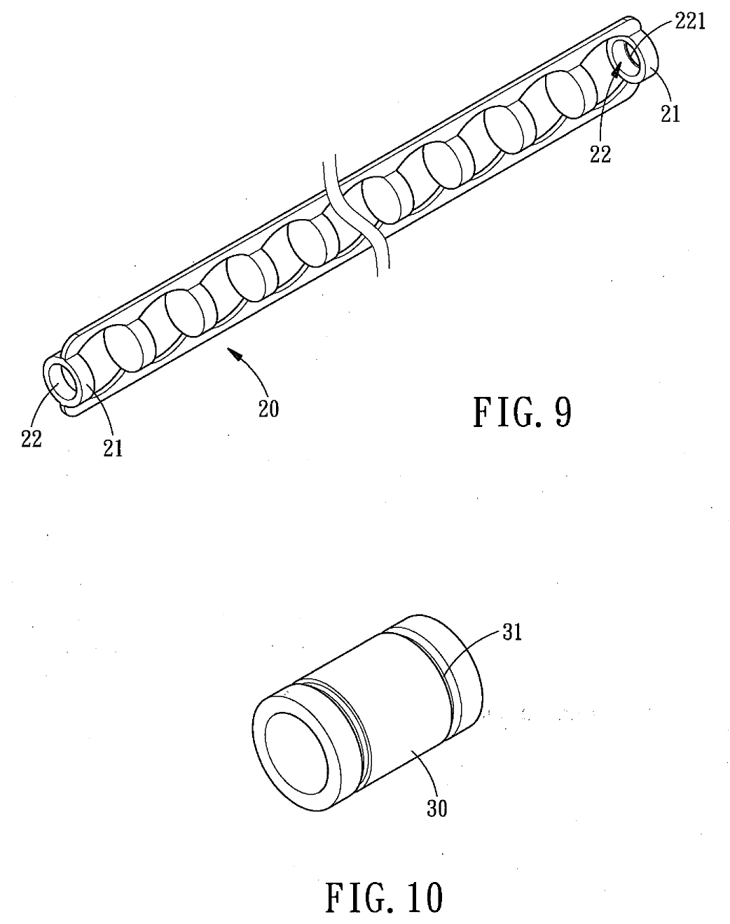

It is to be noted that the connecting member 30 of the present invention also has different embodiments as shown in FIGS. 8-10, 11A and 11B:

The connecting member 30 of the present invention is in the form of a hollow tube which is bendable, both ends of the synchronous connector 20 are formed with two opposite fixing seats 21, each fixing seat 21 is defined with a through hole 22 located correspondingly to the path of the synchronous connector 20, and the through hole 22 has a certain thickness T. In an inner wall of the through hole 22 is defined flanges 221.

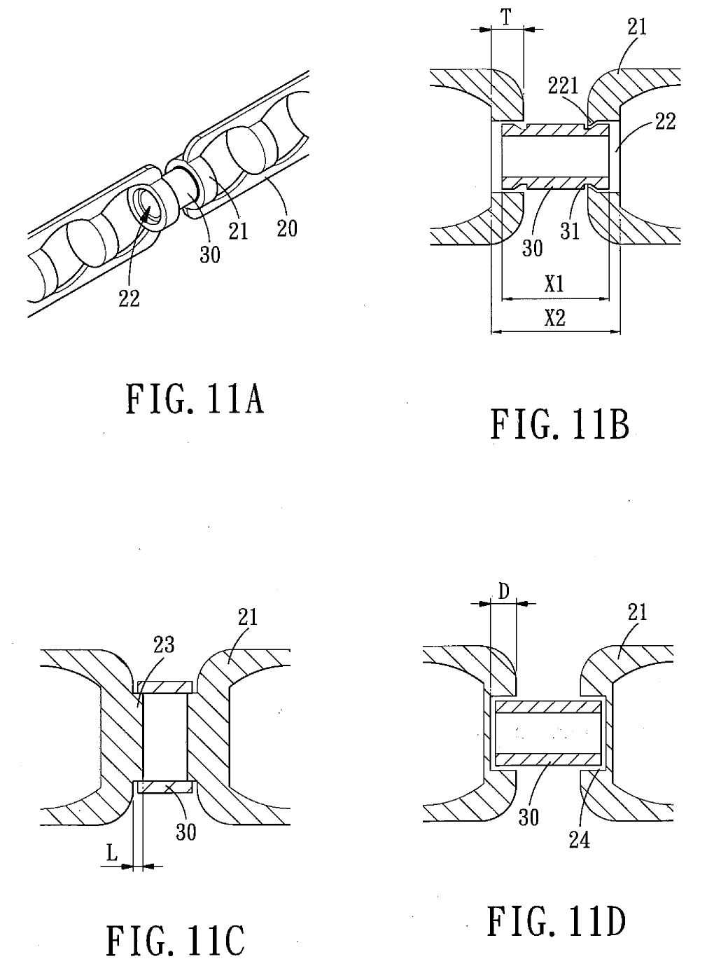

The connecting member 30 is in the form of a hollow tube which is bendable and is fixed in the through holes 22 of the fixing seats 21, and the synchronous connector 20 is defined with positioning grooves 31 located correspondingly to the inner wall of the through holes 22 for insertion of the flanges 221, such that the connecting member 30 is restricted in the thickness T of the through holes 22 of the fixing seats 21. In addition, the sliding distance of the connecting member 30 is larger than zero and smaller than subtract X2 from X1 of FIG. 11B, and with the elastic deformation characteristic, the connecting member 30 can be bent correspondingly to the turning action of the synchronous connector 20.

Therefore, the elastic deformation characteristic of the connecting member 30 can be utilized to avoid the collision interference with the rail wall surface, and the linear guiding device 50 will be circulated smoothly and stably. Further, the present invention has the effect of absorbing the radial deformation of the synchronous connector 20 and producing sufficient degree of freedom.

The following descriptions are the embodiments of the synchronous connector 20 of FIGS. 11C and 11D:

Referring to FIG. 11C, both ends of the synchronous connector 20 are formed with two opposite fixing seats 21, each fixing seat 21 is formed with a concave guiding groove 24 with a certain depth D. The bendable connecting member 30 is in the form of a hollow tube and is received in the guiding groove 24, such that the connecting member 30 is restricted in the depth D of the fixing seats 21. The connecting member 30 will slide radially within the depth D of the guiding grooves 24 when it extends or retracts with respect to the synchronous connector 20, therefore, the connecting member 30 is moveable in radial direction. With the elastic deformation characteristic, the connecting member 30 can be bent correspondingly to the turning action of the synchronous connector 20. By such arrangements, the linear guiding device 50 of the present invention can circulate smoothly and stably, and the present invention also has the effect of absorbing the radial deformation of the synchronous connector 20.

Referring to FIG. 11D, both ends of the synchronous connector 20 are formed with two opposite fixing seats 21, each fixing seat 21 is protrudly formed with a guiding member 23 with a certain length L. The bendable connecting member 30 is in the form of a hollow tube and is provided for insertion of the guiding member 23, such that the connecting member 30 is restricted in the length L of the fixing seats 21. The connecting member 30 will slide radially within the length L of the guiding members 23 when it extends or retracts with respect to the synchronous connector 20, therefore, the connecting member 30 is moveable in radial direction. With the elastic deformation characteristic, the linear guiding device 50 of the present invention can circulate smoothly and stably.

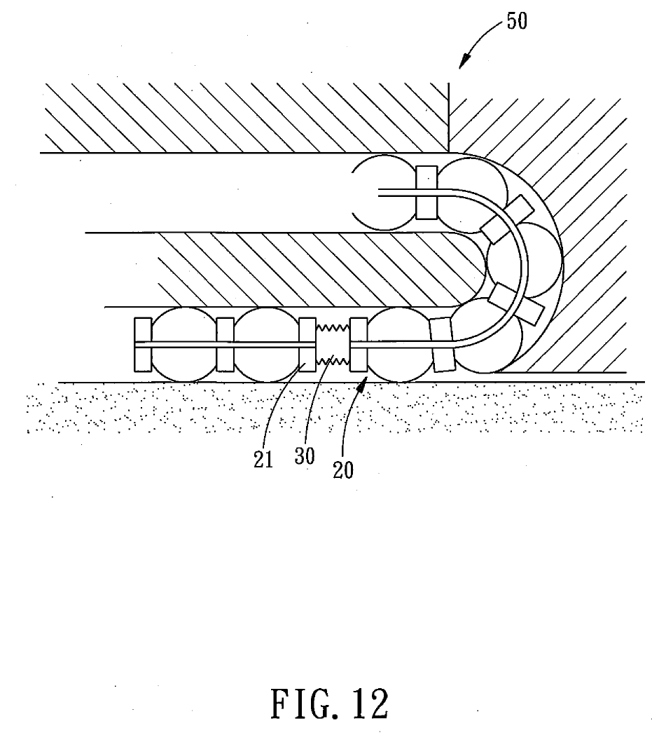

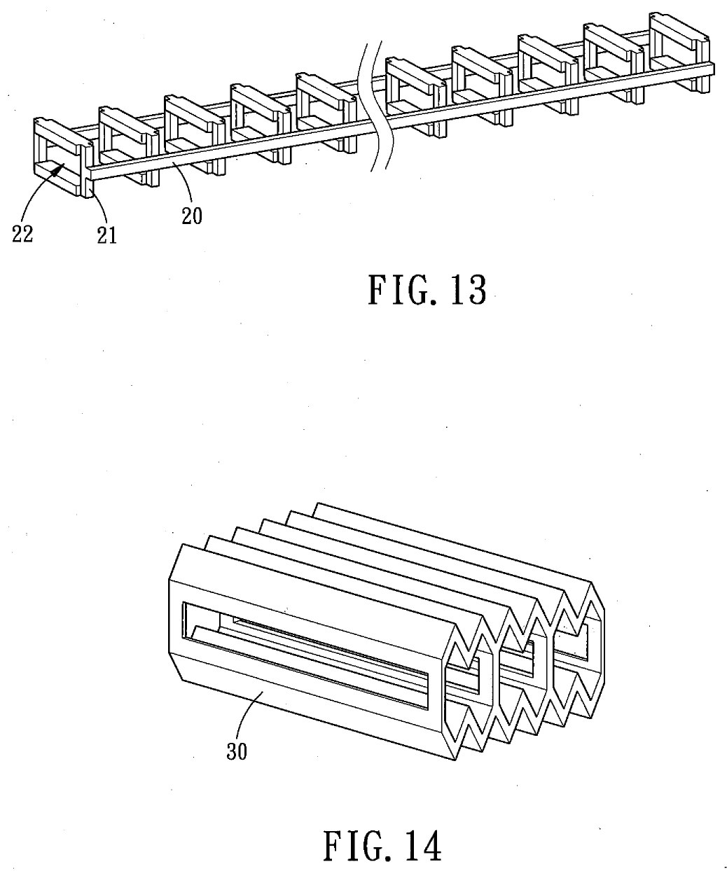

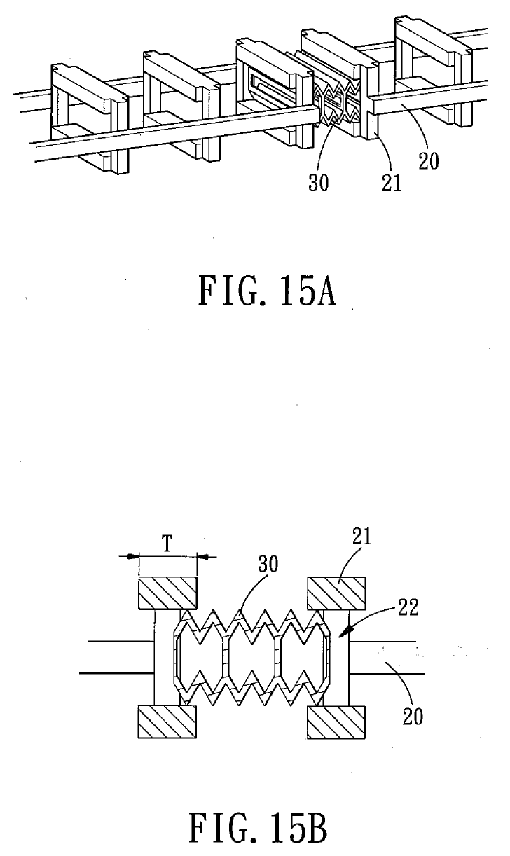

Another embodiment of the connecting member 30 of the present invention is shown in FIGS. 12-14, 15A and 15B:

The connecting member 30 is in the form of a hollow sleeve which is bendable, extensible and retractable, both ends of the synchronous connector 20 are formed with two opposite fixing seats 21, each fixing seat 21 is defined with a through hole 22 located correspondingly to the path of the synchronous connector 20, and the through hole 22 has a certain thickness T, such that the connecting member 30 is restricted in the thickness T of the though holes 22 of the fixing seats 21. Therefore, the elastic deformation characteristic of the connecting member 30 can be utilized to avoid the collision interference with the rail wall surface, and the linear guiding device 50 will be circulated smoothly and stably. Further, the present invention has the effect of absorbing the radial deformation of the synchronous connector 20 and producing sufficient degree of freedom.

In a word, the guiding device 50 for the synchronous connector 20 of the present invention has the following advantages:

Firstly, the elastic deformation characteristic of the connecting member 30 can be utilized to improve the guiding function of the synchronous connector 20 when moving through the return path and to avoid the collision interference.

Secondly, both ends of the synchronous connector 20 are connected to together to form an endless connector.

Thirdly, the sliding of the connecting member 30 is restricted, so as to maintain the radial degree of freedom of the synchronous connector 20.

To summarize, the present invention comprises a strip-shaped synchronous connector and at least one connecting member. Both ends of the synchronous connector are formed with two opposite fixing seats. The connecting member with elastic deformation characteristic is serially connected and fixed in the through holes of the fixing seats at both ends of the synchronous connector, slide correspondingly to the clearance change during the operation of the two ends of the synchronous connector, and bend correspondingly to the turning action of the synchronous connector. By such arrangements, the elastic deformation characteristic of the connecting member can be utilized to avoid the collision interference with the rail wall surface, and the linear guiding device will be circulated smoothly and stably. In addition, the present invention has the effect of absorbing the radial deformation of the synchronous connector and producing sufficient degree of freedom.

While we have shown and described various embodiments in accordance with the present invention, it should be clear to those skilled in the art that further embodiments may be made without departing from the scope of the present invention.

What is claimed is:

1. A guiding device for a synchronous connector, comprising: a slide rail, a slide block and a plurality of rolling elements, a track defined between the slide rail and the slide block for rolling of the rolling elements, the guiding device including at least one synchronous connector and one connecting member, wherein:
the synchronous connector is strip-shaped, the plurality of rolling elements is disposed in the track of the linear guiding device, both ends of the synchronous connector are formed with two opposite fixing seats located correspondingly to the moving direction of the rolling elements; and
the elastic connecting member is serially connected and fixed between the fixing seats at both ends of the synchronous connector.

2. The guiding device for a synchronous connector as claimed in claim 1, wherein the connecting member is a hollow member, and the fixing seats of the connecting member are provided for restricting the connecting member.

3. The guiding device for a synchronous connector as claimed in claim 2, wherein the fixing seat of the synchronous connector is defined with through holes with a certain thickness for receiving both ends of the connecting member.

4. The guiding device for a synchronous connector as claimed in claim 2, wherein each fixing seat of the synchronous connector is defined with concave guiding grooves with a certain depth for receiving both ends of the connecting member.

5. The guiding device for a synchronous connector as claimed in claim 2, wherein each fixing seat of the synchronous connector is defined with convex guiding members with a certain length for receiving both ends of the connecting member.

6. The guiding device for a synchronous connector as claimed in claim 3, wherein the connecting member is in the form of a helical spring which is extensible, retractable and bendable.

7. The guiding device for a synchronous connector as claimed in claim 4, wherein the connecting member is in the form of a helical spring which is extensible, retractable and bendable.

8. The guiding device for a synchronous connector as claimed in claim 5, wherein the connecting member is in the form of a helical spring which is extensible, retractable and bendable.

9. The guiding device for a synchronous connector as claimed in claim 3, wherein the connecting member is in the form of a hollow sleeve which is extensible, retractable and bendable.

10. The guiding device for a synchronous connector as claimed in claim 4, wherein the connecting member is in the form of a hollow sleeve which is extensible, retractable and bendable.

11. The guiding device for a synchronous connector as claimed in claim 5, wherein the connecting member is in the form of a hollow sleeve which is extensible, retractable and bendable.

12. The guiding device for a synchronous connector as claimed in claim 3, wherein each fixing member of the synchronous connector is defined with flanges, the hollow connecting member is defined with fixing grooves for engaging with the flanges.

13. The guiding device for a synchronous connector as claimed in claim 4, wherein each fixing member of the synchronous connector is defined with flanges, the hollow connecting member is defined with fixing grooves for engaging with the flanges.

14. The guiding device for a synchronous connector as claimed in claim 5, wherein each fixing member of the synchronous connector is defined with flanges, the hollow connecting member is defined with fixing grooves for engaging with the flanges.

15. The guiding device for a synchronous connector as claimed in claim 3, wherein both ends of the connecting member are engaged with the fixing seat of the synchronous connector.

16. The guiding device for a synchronous connector as claimed in claim 4, wherein both ends of the connecting member are engaged with the fixing seat of the synchronous connector.

17. The guiding device for a synchronous connector as claimed in claim 5, wherein both ends of the connecting member are engaged with the fixing seat of the synchronous connector.
